(19) United States
(12) Patent Application Publication
(10) Pub. No.: US 2004/0130993 A1
(43) Pub. Date: Jul. 8, 2004

(54) Method and apparatus for a high speed write strategy

(76) Inventor: Nedi Nadershahi, Pleasanton, CA (US)

Correspondence Address: IRELL & MANELLA LLP, 840 NEWPORT CENTER DRIVE, SUITE 400, NEWPORT BEACH, CA, 92660, US

(21) Appl. No.: 10/336,302

(22) Filed: Jan. 2, 2003

(51) Int. Cl. G11B 7/125

(52) U.S. Cl. 369/59.11

(57) ABSTRACT

The present invention relates to a method and apparatus for optimizing a high-speed write procedure, and in particular, a high-speed write procedure on optical media. In one embodiment, a waveform generator accesses tables that define various dynamic write strategy scenarios, thereby enabling dynamic adjustments to laser power levels and/or pulse edges to be made. In another embodiment, a dynamic power control loop is used as a feedback signal and supplied to the dynamic write strategy logic of an optical disk apparatus.

### BACKGROUND

1. Field of Art

The present invention relates to a method and apparatus for optimizing a high-speed write procedure, and in particular, a high-speed write procedure on optical media.

2. Description of the Related Art

Data storage on optical media has been a rapidly developing technology limited in part by the ability to precisely write waveform information to the media at high speeds. To maximize the amount of data which may be stored on optical media, the laser-generated pulses must be formed with precisely selected laser power, as well as position information.

The correct amount of laser power needed for optical media recording is variable and depends on both the individual recorder, media and sometimes even the specific location on the media. Moreover, due to their physical makeup, the various types of materials used in optical media have different sized power windows (i.e., the range of laser energy that will properly form the correct sized pulses on the media) and therefore require different amounts of laser power for proper recording. Power windows can vary not only between the type of media used, but also upon the speed at which the data is being recorded. This is significant since too much power will create oversized pulses, while too little power will produce undersized marks.

The additional fact that the media types have different sensitivities to laser power at different light wavelengths is also important since recorders are allowed to use lasers which operate within an approved range (775 to 795 nm for CD & 625 to 650 nm for DVD) rather than at a single frequency.

In the case of the recorder, the size and optical quality of the laser it uses for writing varies from unit to unit as does its wavelength, which can change depending upon temperature and other environmental conditions. The emission frequency of most lasers is temperature sensitive, and thus writing performed at the extremes of the allowable operational temperature range can result in a significant spread of wavelengths. Consequently, many recorders perform an initial Optimum Power Calibration (OPC) procedure to determine the best writing laser power setting for each disc and recorder combination. In addition, an Automatic Power Control (APC) loops have been employed to overcome very slow changes due to aging and thermal shifts.

Thermal properties of the media and design tolerances of the hardware employed create the need to dynamically adjust write parameters (e.g., laser power, leading edge position, trailing edge position, etc.). While forms of APC and OPC loops have been previously employed to adjust both position and amplitude of the laser-generated pulses, these control loops suffer from numerous drawbacks. The ever increasing demand for storage capacity and access speed necessitates the use of more accurate and responsive control mechanisms. Therefore, there is a need in the art for an improved optical media write strategy.

### SUMMARY OF THE INVENTION

The present invention relates to a method and apparatus for optimizing a high-speed write procedure, and in particular, a high-speed write procedure on optical media. The method for comprises storing write strategy data in a first table, where the write strategy data includes a plurality of waveform formats and dynamic adjustment options for said plurality of waveform formats. The method further comprises accessing the write strategy data by a controller of the optical disk apparatus, and dynamically adjusting a write power level for the write operation based on the write strategy data of the first table. In another embodiment, alternative pulse edge location data is stored in a second table.

Other embodiments are disclosed herein.

### BRIEF DESCRIPTION OF THE DRAWINGS

FIG. 1 is a system block diagram of one embodiment of certain aspects of an optical disk apparatus in which the apparatus and method of the invention is used.

FIG. 2 is a system block diagram illustrating other aspects of the optical disk apparatus of FIG. 1.

FIG. 3 is a system block diagram illustrating yet additional aspects of the optical disk apparatus of FIGS. 1 and 2.

FIG. 4 illustrates a diagram of the write strategy tables according to one embodiment of the invention.

FIGS. 5a-5c contain tabulated data that may be used with the write strategy tables of FIG. 4, according to one embodiment.

FIGS. 6a and 6b depict the contents of the write strategy tables of FIG. 4, according to one embodiment.

FIG. 7 is a flow diagram of a power control process according to the present invention.

### DETAILED DESCRIPTION OF PREFERRED EMBODIMENTS

One aspect of the invention relates to a method and apparatus for providing a fully programmable waveform generator for writing to optical media. In one embodiment, the waveform generator accesses a first table that defines various dynamic write strategy (DWS) scenarios, where the DWS scenarios include the waveform formats (e.g., DVD+RW, DVD-RW, DVD-R, 2T, etc.) and dynamic adjustment options for a given format at various operating speeds. A second programmable table (or set of tables) may then be programmed with alternative address positions of some or all of the pulse edges within a given period of the particular waveform, thereby enabling the pulse edges to be dynamically adjustable.

Another aspect of the present invention is to provide a power control system to optimize the amount of laser power applied to the optical media during write and/or read procedures. In one embodiment, a power control loop, such as a running optimum power control (ROPC) loop, may be used as a feedback signal and supplied to the DWS block of an optical disk apparatus.

A. System Overview

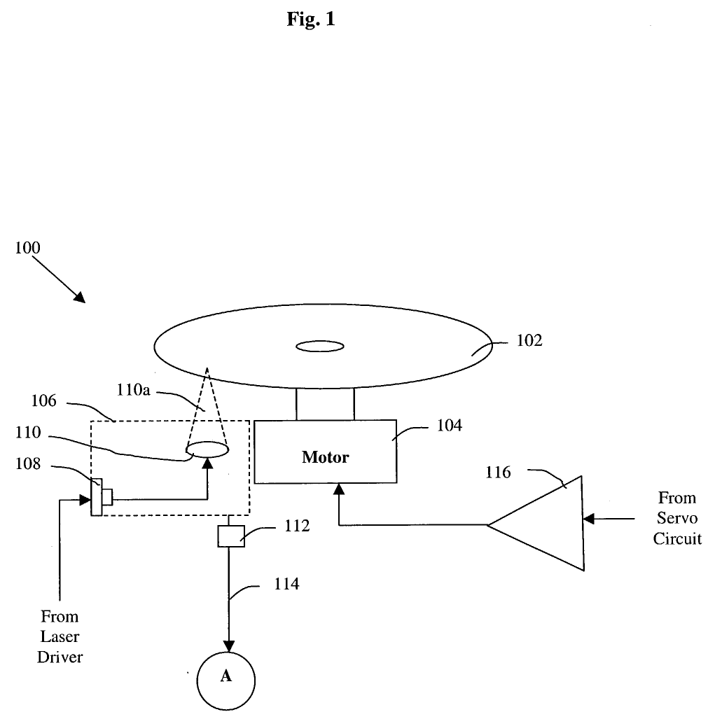

Referring now specifically to the figures, FIG. 1 illustrates one embodiment of certain aspects of an optical disk apparatus 100 consistent with the principles of the invention. The optical disk apparatus 100 includes an optical disk 102 that is rotated by a spindle motor 104. An optical pickup 106 scans the tracks on the rotating optical disk 102 with a laser beam 110a. The optical pickup 106 comprises an optical system, including a laser 108 that provides a light source and an objective lens 110. The laser 108 is driven by a laser driver (not shown) to emit the laser beam 110a. The laser beam 110a is incident on the objective lens 110 via optical elements (not shown) such as a collimator lens and a beam splitter. The laser beam 10a is focused on the recording surface of the optical disk 102 by the objective lens 110 to form a small spot on the recording surface.

The light reflected from the optical disk 102 propagates back to the objective lens 110 and is separated from the incident laser beam by a beam splitter (not shown). The reflected light beam may then be detected by the photodetector 112, which is able to convert the reflected light beam into a digital signal 114. The spindle motor 104 is rotated by motor driver 116. The motor driver 104 may be coupled to and controlled by a servo circuit, such as a CAV servo and/or a CLV servo.

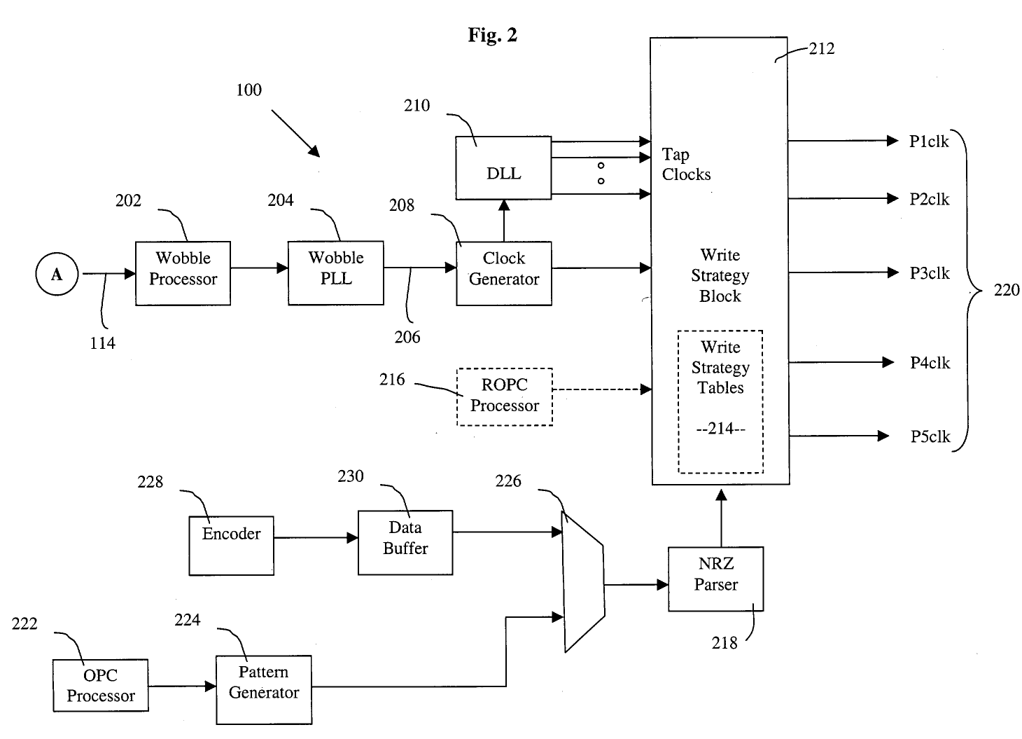

The description of optical disk apparatus 100 continues on FIG. 2 with the digital signal 114 being provided to a wobble processor 202 and a wobble phase-locked loop (PLL) 204. Based on the received digital signal 114, the wobble processor 202 and wobble PLL 204 may generate a plurality of signals, which in one embodiment includes a wobble clock signal 206. In one embodiment, the wobble clock signal 206 is a timing marker that also provides address information. In another embodiment, the wobble clock signal 206 is a frequency modulated Frequency-Shift-Key signal with bi-phase coded address information called ATIP. It should be understood that additional signals may be provided by the wobble processor 202 and wobble PLL 204.

The wobble clock signal 206 may then be provided to clock generator 208, which may be used in dividing the wobble clock signal 206 into write clock pulses. In one embodiment, the output of clock generator 208 is the actual Write Clock that is supplied to the DWS block, which in the embodiment of FIG. 2 is the write strategy block 212. In one embodiment, the write strategy block 212 is part of the controller (not shown) for the optical disk apparatus 100. As shown in FIG. 2, clock generator 208 may also provide the Write Clock to the Delayed Lock Loop (DLL) 210, which is used to further divide the Write Clock frequency to 1/40 taps, where the taps are signals that are delayed from one another by t=1/40 of the Write Clock.

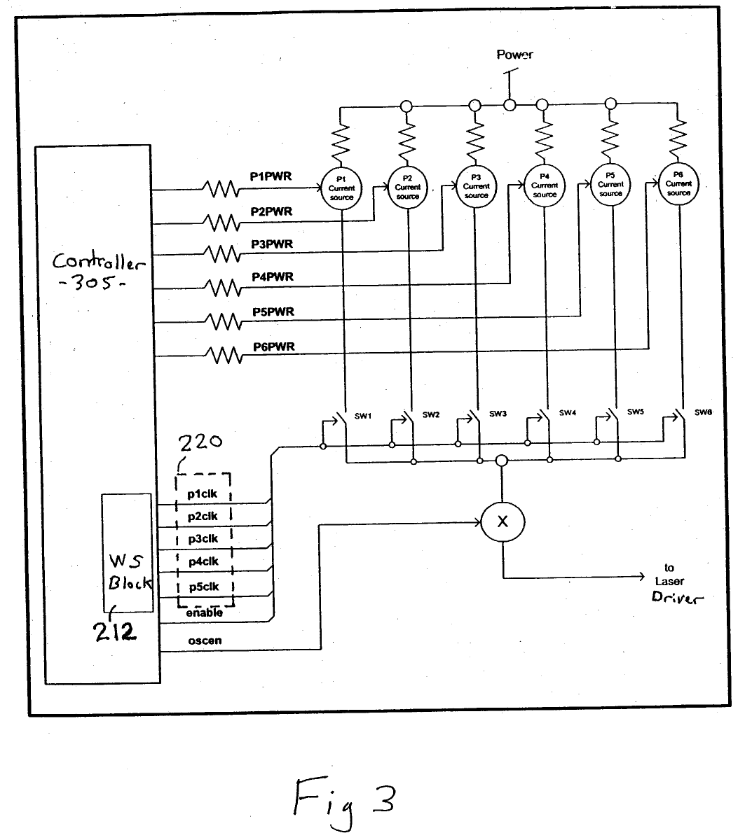

Write strategy block 212, which includes write strategy tables 214 in the embodiment of FIG. 2, is the DWS block which receives the outputs of clock generator 208 and DLL 210. In addition, write strategy block 212 may receive feedback signals from ROPC processor 216 and Non-Return to Zero (NRZ) parser 218, where the NRZ parser 218 may be used to convert NRZ signals into NRZ codes representing symbol information (e.g., 3T, 5T, 8T, etc.). For example, a 5T NRZ signal may be sent out as a 4-bit parallel code of “0101.” Using these various inputs, write strategy block 212 generates the timing clock signals 220 (e.g., P1clk, P2clk, etc.) that are used to select from available power level in creating a modulated output during read and/or write operations, as will be described in more detail below with reference to FIG. 3.

Continuing to refer to FIG. 2, the OPC processor 222 implements the OPC loop and the optional ROPC processor 216 implements the ROPC loop, both of which may be implemented as state machines. It should be appreciated, however, that the OPC processor 222 and optional ROPC processor 216 need not be implemented as state machines, but may instead be implemented in software as well as other means.

While the operations performed by the OPC processor 222 and optional ROPC processor 216 will be described in more detail below in Sections C and D, in general terms the OPC processor 222 interacts with pattern generator 224 to produce write patterns that are used in determining the optimum power levels for a given media/drive environment. In one embodiment, the OPC write patterns are random and range from 3T to 11T patterns, while in another embodiment the OPC write patterns are selected from defined pattern tables. In yet another embodiment, the OPC write patterns may alternate between a 3T pattern and an 11T pattern. In any event, the OPC write pattern to be employed is supplied to NRZ parser 218 after passing through multiplexer 226. As mentioned above, the NRZ parser converts the signals (which in this case are coming from OPC processor 222 and pattern generator 224) into NRZ codes representing symbol information that may then be used by write strategy block 212 in modulating the power level output. During or after the OPC write procedure, the optical disk apparatus 100 may also monitor the reflected light coming back from the disk while or after the marks are formed. As such, encoder 228 may be used to encode this mark formation data for use by write strategy block 212 in determining optimum power level settings.

Referring now to FIG. 3, in which it is shown how the write strategy block 212 may use the timing clock signals 220 to modulate power level output to the laser driver. In the embodiment of FIG. 3, write strategy block 212 is part of controller 305, which may be used to control all or some functions of the optical disk apparatus 100. In addition, while the embodiment of FIG. 3 depicts six different available power levels, there may also be more or fewer available power levels. As shown in FIG. 3, timing clock signals 220 are used to operate switches SW1-SW6, which cause current sources P1-P6 to supply varying levels of power to the laser driver (not shown) during read and/or write operations.

B. Programmable Write Strategies

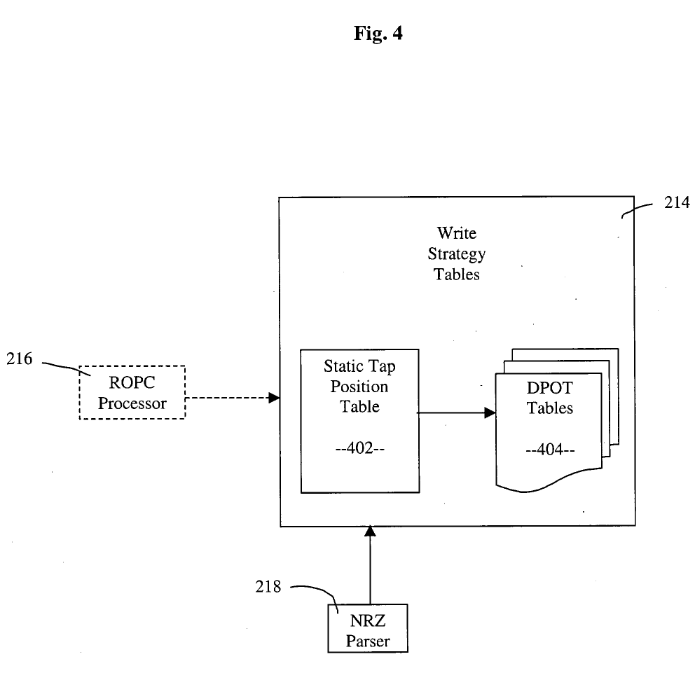

Referring now to FIG. 4, in which the write strategy tables 214 are depicted. In this embodiment, the write strategy tables 214 include a Static Tap Position (STP) Table 402 and one or more Dynamic Position Offset (DPO) Tables 404. As mentioned previously, the write strategy tables 214 enable the optical disk apparatus 100 to be fully programmable such that emulation of all known write strategy schemes is possible.

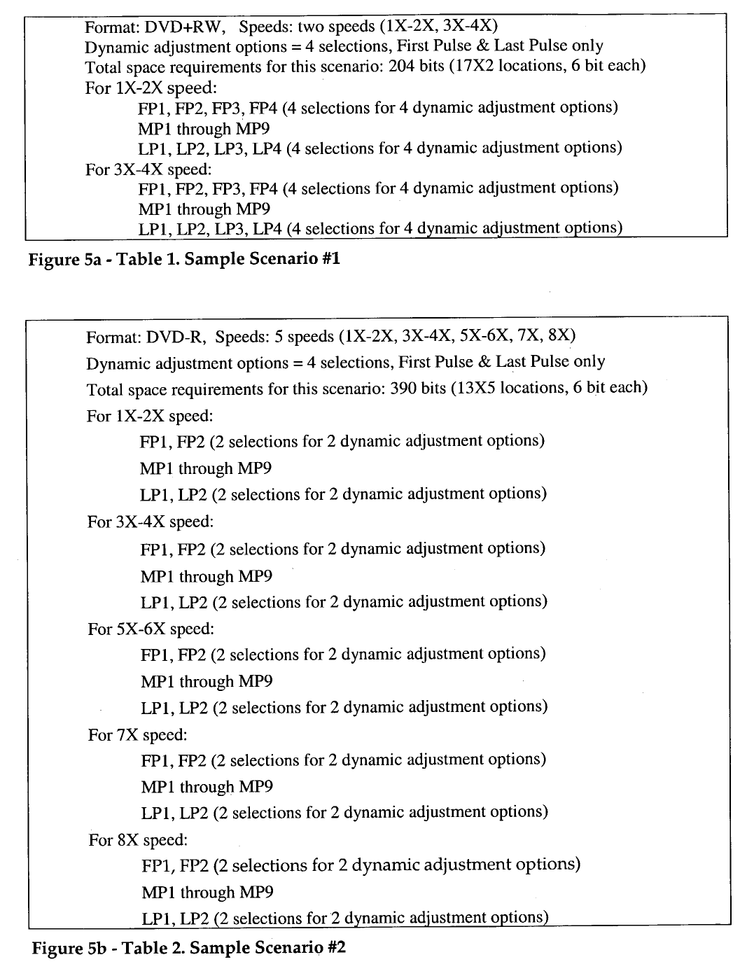

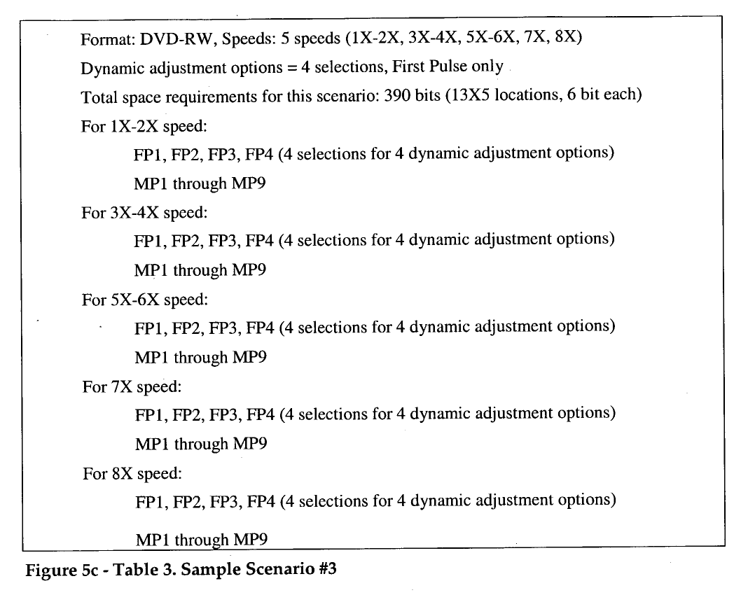

In one embodiment, the STP Table 402 is implemented as a hard-wired table, while in another embodiment it may be physically implemented as multiple tables. Address to the STP Table 402 may be provided via the NRZ parser 218. The STP Table 402 will sequence through consecutive addresses on every “T” clock cycle to produce information about each “T” cycle for a given media/speed selection. FIGS. 5a-5c containing Tables 1-3 are provided as three examples illustrating the typical data content of the STP Table 402. In the embodiments of FIGS. 5a-5c, all scenarios include a first pulse, up to nine middle pulses and a last pulse.

Referring back to FIG. 4, optional ROPC processor 216 may be used to provide a feedback signal to the DWS (e.g., write strategy block 212). Moreover, DPO Tables 404 may be programmable via firmware. In one embodiment, the contents of the DPO Tables 404 are the address positions of the pulse edges within the “T” period for each of the scenarios of the STP Table 402. In one embodiment, each location addressed by the STP Table 402 contains three 6-bit addresses pertaining to the three possible edges within the “T” period. It should of course be appreciated that the DPO Tables 404 may contain more or fewer than three addresses and that any such addresses may be comprised of more or fewer than 6-bits.

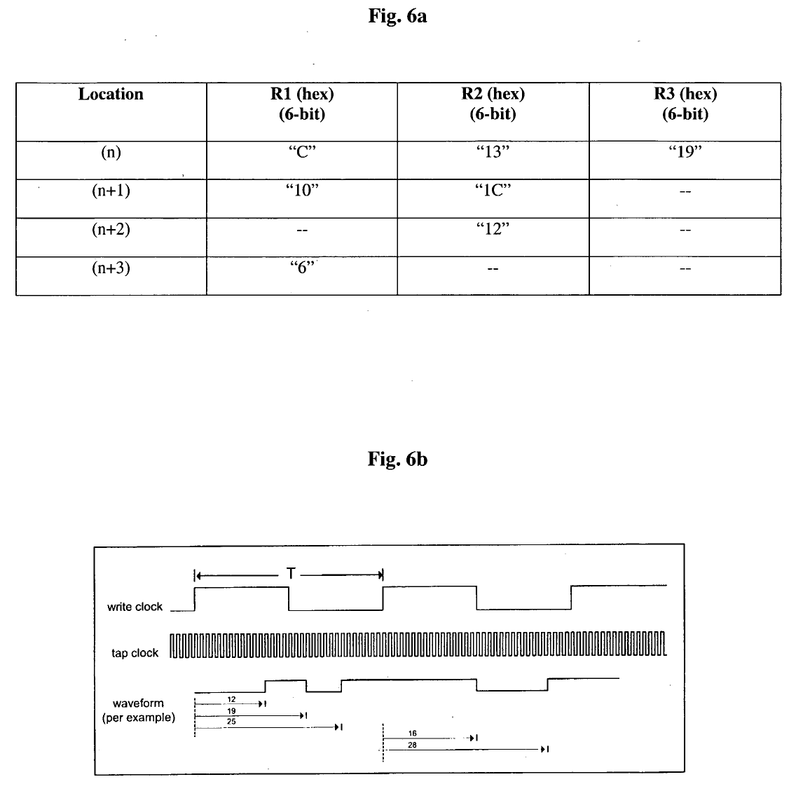

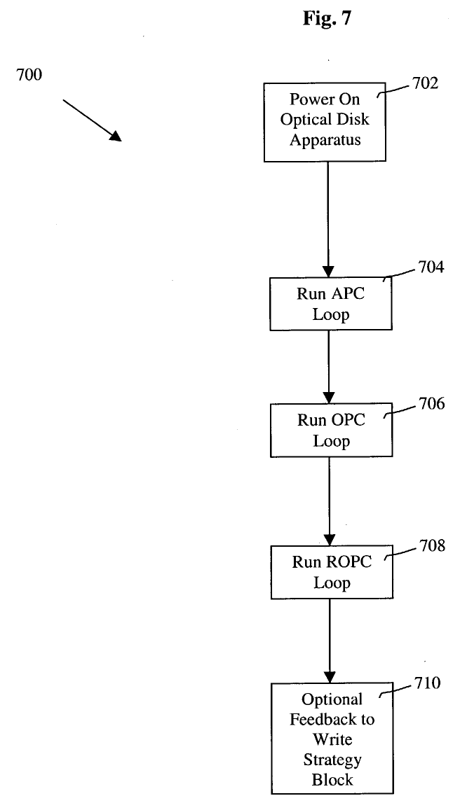

By way of providing a non-limiting example, FIG. 6a contains exemplary data for the DPO Tables 404, while FIG. 6b is a graphical representation of such data. In particular, in the example location (n) of FIG. 6a, the first edge address is at location “C” hex, the second edge address is at “13” hex, and the last edge address is located at “19” hex. Similarly, in the example location (n+1), the first edge address is located at “10” hex, while the second edge is located at “1C” hex.

By providing completely programmable write strategy tables 214, the optical apparatus disk 100 provides complete flexibility over pulse train programming, which may include pulse edge positioning in the resolution of 1/40T, pulse width programming in the resolution of 1/40T, and/or pulse scenario/number programming. In addition to conventional write strategy schemes, the write strategy tables 214 make it possible to implement 2T write strategy, as well as the DVD-R write strategy.

C. Power Control

The power supplied to laser 108 may be controlled by up to three separately executing control loops. Referring now to FIG. 7, process 700 depicts a laser power control process, according to one embodiment. After power is supplied to optical disk apparatus 100 (block 702), an APC loop may be activated at block 704. The APC loop may be implemented using optical pickup unit 106 which include a monitor diode (not shown) to constantly monitor the laser power applied to the media during read or write operations. In one embodiment, this feedback operates at a relatively low bandwidth and is used to regulate slow changes due to, for example, aging and thermal drifts.

In addition to the APC loop, the optical disk apparatus 100 may further employ an OPC loop that is used to determine the best writing laser power settings for the particular disk/recorder combination (block 706). In one embodiment, the OPC loop begins with the recorder retrieving an initial Recommended Optimum Recording Power estimate value (for a writing condition of 650 nm at 25 degrees Celsius) from the Land Pre-Pit or ADIP wobble information encoded in the Lead-In Area of the disc. Using this setting as a starting point, the laser 108 is stepped through higher and lower laser power settings while writing test information in a special reserved space of the disc called the Power Calibration Area (PCA), located before the disc's Lead-In Area. By way of providing a non-limiting example, a recorder might obtain a beginning recording value of 5.9 mw from a disc and write fifteen times (15 wobble sync frames or a fifth of a second) in the PCA with power ranging from 4.1 to 11.7 mw. After writing the test marks at the different laser powers the recorder reads them back and looks for differences (asymmetry or beta) between the lengths of marks and lands. A negative beta means that, on average, the marks are underpowered (short) and a positive beta means that they are overpowered (long). To be broadly compatible with the various available types of media, the system may use a beta of +4%, although multiple target betas may also be used for various write scenarios. The optical disk apparatus 100 then determines what setting achieved the +4% beta target and establishes that as the recording power for the disc (hereinafter referred to as the “initial optimum power setting”).

In addition to the APC and OPC power control loops, a third control loop, referred to herein as the Running OPC loop or ROPC, may be used to monitor and maintain the quality of writing by ensuring the accuracy of all marks and lands across the disk (block 708). During the initial OPC procedure of block 706, the optical disk apparatus 100 may also monitor the reflected light coming back from the disk while the marks are forming and store that information. After determining the initial optimum power setting, the reflected signal that is associated with it may be retrieved. Thereafter, a mark formation signature may be established and saved to memory. During recording, the optical disk apparatus 100 monitors the marks as they form on the disk using the reflected light and compares these signals against the signature established during the initial OPC procedure, according to one embodiment. Laser power may then be adjusted on the fly throughout the writing process to maintain this optimum condition. By way of example, if the device encounters a condition that reduces the amount of laser light reaching the media recording layer (dust, scratches, fingerprints, etc.), rather than the resulting mark being too short, ROPC will detect the change in the reflected light signal relative to the stored signature and increase the laser power to attempt to compensate.

It should be appreciated that these ROPC adjustments may proceed according to an algorithm and, in one embodiment, may proceed according to the algorithm and method set forth in the co-pending application having Ser. No. ______, entitled “Laser Disc Signal Monitoring and Control,” which has been assigned to the assignee hereof, and which is hereby fully incorporated by reference. Other methods of performing the ROPC adjustments may similarly be employed.

In another embodiment, the above control schemes may further be supplemented with the use of a Direct Read After Write (DRAW) system, which uses a second laser trailing the writing laser to determine if the correct data has been recorded on the disk. In yet another embodiment, the user may make a verification pass after writing, as is done in Magneto-Optical (MO) and many other storage devices. It should further be appreciated that other forms of data verification known in the art may also be used in conjunction with the present invention.

D. ROPC Feedback Loop

As mentioned above, one embodiment of the invention is to provide a feedback signal to the DWS from the ROPC loop. While ROPC corrections are intended to recover power loss due to marks or debris on the media, one aspect of the present invention is to use the ROPC data to supplement the DWS. In one embodiment, ROPC processor 216 generates a power control signal that is provided to write strategy block 212. Based on the power control signal provided by ROPC processor 216, write strategy block 212 may then access write strategy tables 214 and implement dynamic adjustments to the DWS for a given scenario. Dynamic adjustments to the DWS may proceeds based on the feedback power control signal from an ROPC loop, a DWS feedback loop, or any combination thereof.

Although the present invention has been described in terms of certain preferred embodiments, other embodiments apparent to those of ordinary skill in the art are also within the scope of this invention. Accordingly, the scope of the invention is intended to be defined only by the claims which follow.

What is claimed is:

1. A method for optimizing a write operation of an optical disk apparatus, comprising:
storing write strategy data in a first table, said write strategy data to include a plurality of waveform formats and dynamic adjustment options for said plurality of waveform formats;
accessing said write strategy data in said first table by a controller of the optical disk apparatus; and,
adjusting, dynamically, a write power level for said write operation based on said write strategy data.

2. The method of claim 1, further comprising storing alternative pulse edge location data in a second table.

3. The method of claim 2, further comprising adjusting a pulse edge location during said write operation based on said alternative pulse edge location data from said second table.

4. The method of claim 2, wherein said first table is at least partially populated with said alternative pulse edge location data from said second table.

5. The method of claim 2, wherein said alternative pulse edge location data is stored in a plurality of second tables, where each of said plurality of second tables is associated with each of said plurality of waveform formats.

6. The method of claim 1, wherein said waveform formats include DVD+RW, DVD-RW, DVD-R, and 2T.

7. The method of claim 1, wherein said first table is stored in a dynamic write strategy block of said controller.

8. The method of claim 1, further comprising executing a running optimum power control (ROPC) loop for said optical disk apparatus, where said ROPC loop is used to dynamically detect changes in said write operation of said optical disk apparatus.

9. The method of claim 8, wherein said ROPC loop provides a dynamic feedback signal indicative of said changes, and said adjusting the write power level comprises adjusting the write power level for said write operation based on said write strategy data and said dynamic feedback signal.

10. An optical disk apparatus, comprising:
a laser to perform a write operation on an optical medium;
a controller coupled to the laser; and,
a memory, coupled to the controller, containing a first table comprised of write strategy data, said write strategy data to include a plurality of waveform formats and dynamic adjustment options for said plurality of waveform formats, said memory to contain an instruction sequence to cause said controller to,
access said write strategy data in said first table and, adjust, dynamically, a write power level for said write operation based on said write strategy data.

11. The apparatus of claim 10, wherein said memory further contains a second table comprised of alternative pulse edge location data.

12. The apparatus of claim 11, wherein said memory further includes instruction sequences to cause said controller to, adjust a pulse edge location during said write operation based on said alternative pulse edge location data from said second table.

13. The apparatus of claim 11, wherein said first table is at least partially populated with said alternative pulse edge location data from said second table.

14. The apparatus of claim 11, wherein said alternative pulse edge location data is stored in a plurality of second tables, where each of said plurality of second tables is associated with each of said plurality of waveform formats.

15. The apparatus of claim 10, wherein said waveform formats include DVD+RW, DVD-RW, DVD-R, and 2T.

16. The apparatus of claim 10, wherein said first table is stored in a dynamic write strategy block of said controller.

17. The apparatus of claim 10, further comprising executing a running optimum power control (ROPC) loop for said optical disk apparatus, where said ROPC loop is used to dynamically detect changes in said write operation of said optical disk apparatus.

18. The apparatus of claim 17, wherein said ROPC loop provides a dynamic feedback signal indicative of said changes, and said adjusting the write power level comprises adjusting the write power level for said write operation based on said write strategy data and said dynamic feedback signal.
